(19) United States
(12) Patent Application Publication
(10) Pub. No.: US 2010/0187910 A1
(43) Pub. Date: Jul. 29, 2010

(54) Method and system for wireless delivery of power and control to a miniature wireless apparatuses

(76) Inventor: Alexander Brengauz, Huntington Beach, CA (US)

Correspondence Address: Alexander Brengauz, 9531 Landfall Drive, Huntington Beach, CA, 92646, US

(21) Appl. No.: 12/590,165

(22) Filed: Jan. 29, 2008

(51) Int. Cl. H02J 17/00

(52) U.S. Cl. 307/104

(57) ABSTRACT

A system and method for delivering power and means of control to a variety of wireless apparatuses by wireless means. Specifically, the batteries, used for functioning of the wireless apparatuses are replaced with a power capturing modules, and the power for such a modules are delivered externally by means of electromagnetic or/and ultrasonic waives. This named waives, that are used for delivery of a power, are also used as a carriers for control commands that are used as a signal for adjustments and manipulations, necessary for regular functioning of the named miniature wireless apparatuses during their normal exploitation.

### REFERENCES CITED

U.S. patent Documents

| | | |
|---|---|---|
| Feb. 21, 2006 | 7,003,350 | Denker. et al. |
| Apr. 11, 2006 | 7,027,311 | Vanderelly, et al. |
| Aug. 2, 2007 | 7,253,571 | Kang et al. |
| Dec. 27, 2007 | 20070298847 | Karaoguz; Jeyhan; et al. |
| Oct. 16, 2003 | 20030193791 | Panella, Augusto, et al. |

### BACKGROUND OF INVENTION

This invention relates to the varieties of a handheld, stand alone, pocket size, ears wearing and other miniature wireless devices that presently rely on the battery to provide power for their functioning. As an example of such a devices are the hearing aids, Bluetooth, remote controls, medical implants. This invention will be thereof described, but not limited to, on hearing aids as an example.

There are, basically, two different concepts of functioning of hearing aid devices: Body-Worn-Aids and Ear-Worn-Aids. The Ear-Worn-Aid included Behind-The-Ear and In-The-Ear canal aids.

The Body-Worn-Aid has a sound receiving device (microphone), amplifier, sound level control and power supply worn outside the body and is connected to the receiver (the speaker) in the ear canal by means of the wire or tube.

The Ear-worn-Aid aid is basically a miniaturized body warn device that has microphone, amplifier, control circuit, speaker and power battery as one unit worn behind the ear or in the ear canal.

The Body-Worn-Aid have a good range of control and power, but needs a wire or tubes for delivering sound to the ear, i.e. it lacks of convenience.

The Ear-Worn-Aid devices are much more convenient and less visible, but when the need for level of sound control arise, the inconvenience are obvious (one shall literary stick a finger in to the ear to make an adjustment) and there is a frequent and very inconvenient way to change and dispose the tiny and expensive batteries. With the development of the nano-electronic industry with extremely small and low power consumption circuits, the battery will became the major obstacle to minimizing the size of wireless devices.

Therefore removing wire or tube from Body-Worn-Aid devices and eliminating control circuit and battery from Ear-Worn-Aid devices will greatly improve the functionality of hearing aids of both named above concepts.

### SUMMARY OF INVENTION

The scope of this invention is the method for delivering the power and control to a variety of remote wireless devices by wireless means, which eliminates the use of batteries used by sad wireless devices and the necessity for their constant charging. More precisely, the present invention provides a method for supplying the miniature wireless devices that presently require a battery for their functioning, by wireless means from a remote, on body worn or stationary power providers, that emits the power and provides the control, required for named miniature wireless devices functioning, by means of electromagnetic or ultrasonic waives.

The described in a BACKGROUND of INVENTION chapter above two principles, named first and second, of hearing aids functioning in present invention is described as a system of two modules: Power-Provider module of first principle with a microphone and control outside the ear as on Body-Worn-Aid, and Power-Acceptor module that use microphone and control from Power-Provider module of first principle, and Power-Provider module of second principle, without microphone, but with control for Power-Acceptor module of second principle with microphone, as on the Ear-Worn-Aid of described second principle.

More precisely, the introduced system that functioning as described First Principle of exemplary of present invention of hearing aid incorporates power battery, microphone, sound level control circuit and power transmitter, while the Power-Acceptor module incorporates power receiver and speaker.

Power-Provider module, that is functioning as a Second Principle of an exemplary hearing aid incorporates power battery, sound level control circuit and power transmitter, while the Power-Acceptor module incorporates power receiver microphone and speaker.

The above two principals of this invention designs are differ physically by the placement of the microphone, but could provide a greater flexibility and convenience for manufacturing. That is why they both are included in description of this invention.

### BRIEF DESCRIPTION OF THE DRAWINGS

A preferred exemplary of embodiment of a hearing aid system in accordance with the present invention will be described in conjunction the appended drawings:

FIG. 1. is a functional block diagram, which depicts the named above the First Principal of system functioning in accordance with present invention

FIG. 2. is a functional block diagram, which depicts the named above Second Principal of system functioning in accordance with present invention

### DETAILED DESCRIPTION OF A PREFERRED EXEMPLARY EMBODIMENT

In accordance with the present invention, there are drawings with a description of the principles of functioning for preferred embodiment hearing aids sample.

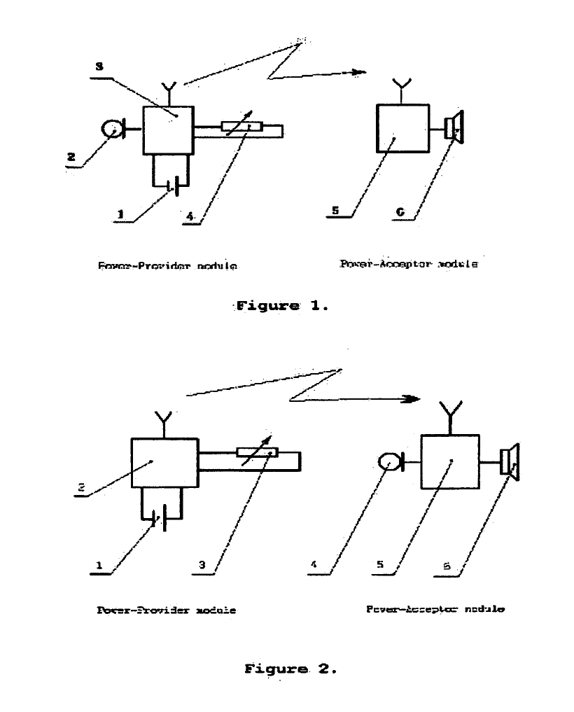

Referring to FIG. 1. there is a block diagram that depicted the two modules of preferred embodiment of hearing aid that describes as First Principle of functioning with accordance with the present invention, where:

The Power-Provider module incorporates a battery 1 as a power source for power transmitting circuit 2, with incorporated the power frequency generator, mixer (not shown), and transmitting device, depicted as antenna 4. The microphone 3 is a voice input to the frequency mixer, and adjuster 5 is a level control for a control circuit 2. The named adjuster 5, shown as a potentiometer, is providing manual adjustment for a level of the modulated voice signal from microphone 3.

All components of electronic circuit are the subject of different waves transmitting/receiving theory, and as a common knowledge are not the subject of present invention. The core of the present invention is in the level of power produced by wave generator and its use for powering of the close distance positioned Power-Acceptor module, and use of this power for manipulating the outcome of the Power-Acceptor module. Shortly, manipulating the power of the voice level of the speaker 7 of the Power-Acceptor module remotely, by manually adjusting a level of the modulated frequency on the Power-Provider module.

The modulated frequency from Power provided module is captured by Power-Acceptor module by Power-Receiver circuit 6. This circuit extracts the modulated frequency from the carrier frequency. The carrier frequency is used for generating power, with a level (typically 3 Volts), necessary for functioning of the potentially, but not necessary, needed amplifier and/or speaker 7 of the Power-Acceptor module.

Referring to FIG. 2, there is a functional block diagram, which depicts the two modules of preferred embodiment of hearing aid, the Power-Provider module and Power-Acceptor module, which describes the Second Principle of its functioning in accordance with the present invention, where:

The Power-Provider module of preferred embodiment of hearing aid incorporates the power battery 1, control circuit 2 and power transmitting circuit 3. The control circuit is controlled by manual adjuster 4, shown as a potentiometer, and provided for a level of the power level of the carrier waives. This change in a value and/or volume of carrier is a subject for the Power-Acceptor module for it interpretation as a command for signal manipulation, such as for example, to make adjustment for the power outcome of the sound level. The carrier frequency, emitted from Power-Provider module is captured by the power receiver circuit 6 of the Power-Acceptor module. This circuit transforms the captured oscillating power to a power level suitable for functioning of the microphone 5, power receiver circuit 6 and speaker 7 of the Power-Acceptor module (typically 3 Volts).

It should be understood, that the description of the present invention is made on the exemplary application for hearing aid for description purpose only, and there could be many modification, due to a variety of applications. As for example for the remote control application the Power-Provider module can be wall mounted and doesn't need any adjustment circuits, while Power-Acceptor module could be hand held remote control module, that is using power emitted from wall mounted part, only as a power for uninterruptible charge of its battery or accumulating capacitors.

For medical implants the Power-Provider module can produce power and control signal or only power or only a control signal for Power-Acceptor module, that in this arrangement could be an implant itself.

These and other modifications may be made in the design and arrangements of the elements without departing from the spirit and scope of the invention as expressed in the appended below claims.

What is claimed:

1. A system comprising of two modules:
a) Module 1—a generator of electromagnetic waives, that emits power waves for wirelessly providing a power to the variety of wireless handheld, hearing aids, medical implants and similar modules, that otherwise use a battery for their functioning.
b) Module 2—wireless handheld, ear worn, medical implant or similar module, that is equipped with an electronic circuit for accepting and transforming the emitted from named module 1 generator, that provides the electromagnetic power waives, to a power level, suitable for proper functioning of sad wireless, handheld modules.

2. A system of claim 1, where the electromagnetic waves are substituted by ultrasonic waves and generator module is producing the ultrasonic power for the variety of the wireless handheld, hearing aids, medical implants and similar modules, that otherwise are use a battery for their functioning. And the named wireless modules are equipped with a circuit that accepts and transforms the emitted from sad generator ultrasonic waives to a form suitable for proper functioning of sad wireless, handheld modules.

3. A system and method wherein the generator of electromagnetic or ultrasonic power waives of claims 1 and 2 is equipped by a circuit for manipulating the named power waives in a specific order that, when received by a wireless handheld, ear worn, medical implant or similar devices of claims 1 and 2, that are equipped with an electronic circuit, for transforming and decoding the manipulated power waives emitted by power provider generator of clams 1 and 2 and interpreted the manipulated power signals as a control commands that is used for necessary adjustment in process of functioning of sad wireless power accepting modules of clams 1 and 2. It simply may be described as a remote control of described miniature devises.
